(19) United States
(12) Patent Application Publication
(10) Pub. No.: US 2002/0076819 A1
(43) Pub. Date: Jun. 20, 2002

(54) Paperless chain of custody evidence for lab samples

(76) Inventors: Danny Charles Bowman, Greensboro, NC (US); Jason Thomas Bowman, Greensboro, NC (US); David Mike Lewis, Greensboro, NC (US); Richard Kim Paisley, Greensboro, NC (US)

Correspondence Address: RHODES & MASON, P.L.L.C., P.O. BOX 2974, GREENSBORO, NC, 27402, US

(21) Appl. No.: 09/737,185

(22) Filed: Dec. 14, 2000

(51) Int. Cl. B01L 3/02

(52) U.S. Cl. 436/56; 422/102

(57) ABSTRACT

A paperless system for identifying and controlling biomedical specimens and managing essential information associated with such specimens. The invention provides a diagnostic or toxicology specimen container having an electronic memory tag for remote non-contact recording and reading of data stored therein. The invention also provides improved methods for controlling the identity of such specimens, coordinating the relay of such specimens between remote specimen collection sites and reference laboratories, and managing essential information associated with such specimens by using the electronic memory tags.

### BACKGROUND OF THE INVENTION

The present invention relates to improvements in identification, logistics control, and information management for biomedical specimens collected for diagnostic or toxicology testing. Diagnostic and toxicology specimens are typically collected for analytical testing from donors at collection sites such as hospitals, clinics, or doctors' offices. These specimens are collected in primary specimen containers specifically designed to completely and safely contain the specimens during handling and shipment in order to preserve the integrity of the specimens and to protect the health of persons who come in contact with the containers. In addition, primary toxicological specimen containers are typically provided with tamperproof locks or seals to ensure that the integrities of the toxicological specimens are not breached by unauthorized persons or by mishandling of the containers.

Diagnostic and toxicology testing requires the collection, recording, and maintenance of essential information about each diagnostic or toxicology specimen. Such information includes the identity and nature of each specimen, the identity of the specimen donor, the test or tests to be performed on the specimen, the identity of the person collecting the sample, the time and place of collection, and the results of tests performed on the specimen. Also, toxicology specimens typically require written authorizations signed by their donors. Because most specimen collection sites do not have testing laboratories on site, the specimens are typically sent to remote reference laboratories. Accordingly, the pertinent information about a particular specimen must be accurately communicated to the laboratory which tests the specimen, and the laboratory must in turn accurately report the test results for that specimen back to the site where the specimen was originally collected or to another remote site.

The recording, maintenance, and communication of specimen and testing information is currently done using preprinted duplicate-page forms having spaces for manually entering designated information onto the forms. Duplicate copies of the completed forms are used for communicating and recording information among and between multiple departments or sites involved with the handling or testing of a specimen. It is common for such forms to have sequential numbers and bar codes that correspond to matching bar coded labels which can be affixed to the specimen containers corresponding to the written information on the associated forms. These bar codes can be scanned to identify the specimens contained in the bar-coded containers, and the bar codes on the forms can be scanned to correlate the recorded information with the specimen. In addition, written or typed information is often included on labels on the specimen containers to show details about the contained specimens. The primary specimen containers and copies of the associated forms are typically maintained together by placing them together in secondary containers such as boxes or sleeves. These secondary containers are then transported to a reference laboratory to conduct the required tests on the specimens.

Particularly for toxicology specimens such as urine specimens to be tested for illicit drugs, legal evidence linking the specimen to be tested to the donor is critical. Prior efforts to assure this linkage include chain of custody bags and forms taught in U.S. Pat. No. 5,135,313 to Bowman and U.S. Pat. No. 4,873,193 to Jensen et al., and British Patent Application 2,221,208.

Because the specimens originate from multiple remote collection sites, the collection and delivery of such specimens requires coordination between the collection sites, the laboratory, and a courier. Because many collection sites have only a sporadic need for diagnostic or toxicology testing, it is often inefficient for a designated courier to visit a potential collection site daily or semi-daily to possibly collect specimens for delivery. In order to avoid such inefficiency, collection sites must typically notify either the laboratory or a courier each time specimens are awaiting collection for delivery to the laboratory, causing a different type of inefficiency.

Modem reference laboratories typically include automated handling and testing equipment. Such laboratories have automated sorters and conveyors for routing specimens to testing stations and testing equipment that automatically performs the required tests on the specimens with minimal manual human intervention. However, even such automated laboratories must receive and inventory specimens from remote specimen collection sites by manually unpacking each specimen and the associated forms from their boxes or sleeves. The laboratories typically use manual bar code scanners to individually scan the bar code labels on the received specimen containers and forms and then manually input data into computers that control the automated handling and testing equipment. The specimens are manually staged for introduction into the automated systems. Once testing has been performed on a specimen, a laboratory typically records the test results manually on the associated forms and then reports the test results by sending the completed forms to the originating specimen collection site or other selected destination.

As can be appreciated by those skilled in the art, the current methods for information management and logistical control for biological specimens collected for diagnostic or toxicology testing include a number of difficulties. The use of written forms and written labels to record, maintain, and communicate specimen information is especially problematic. Manual entry of information onto forms or labels at collection sites and laboratories is labor intensive and causes delays in processing the specimens and information. Also, written forms or labels may be illegible or may become obliterated by handling or spills, causing a loss or miscommunication of essential information. Furthermore, it is necessary to physically maintain copies of the forms with the associated specimens. These forms add bulk to transport packaging for the specimen containers, and may be lost or dissociated from the specimens. In addition, the forms must be individually handled and scanned or read when received by a reference laboratory, adding labor cost and causing delays leading to underutilization of the automated laboratory handling and test equipment. Lost or dissociated forms may cause potentially harmful delays in the testing or reporting of diagnostic test results for distressed donors experiencing medical emergencies. In addition, if a form containing an authorization signature of a toxicology specimen donor is lost or misplaced, the test cannot be performed until the donor again authorizes the test.

While the use of bar codes has proved useful for the identification, control, and correlation of specimens and specimen forms, it has not eliminated the need for written forms to record and manage specimen information nor the associated problems. In addition, the bar codes on specimens and forms must be individually scanned and convey only limited basic identity information about the specimens.

Also, because independent specimen collection sites may generate specimens only sporadically, the process of collecting specimens from these sites is problematic. Having couriers regularly visit sites having no specimens for collection wastes labor and transportation costs. Alternatively, having the sites request collection on a case-by-case basis is labor intensive and subject to communication delays or miscommunication.

Accordingly, there is a need in the art for an improved system for managing information for biomedical specimens collected for diagnostic or toxicology testing and for coordinating the relay of specimens between remote collection sites and reference laboratories.

The present invention uses electronic memory tags on diagnostic or toxicology specimen containers to meet this need. Radio Frequency Identification (RFID) systems featuring so-called “smart tags” or “smart labels” and the associated electronic devices for remotely writing information to and reading information from these smart tags or labels are known. Similar electronic tags were developed by the United States National Laboratory at Los Alamos, N.Mex. for the Department of Agriculture to identify and track livestock animals. One supplier, Texas Instruments, Inc., markets such RFID products and systems under the trademark TAG-IT®. As this technology has developed, RFID systems have been used to address a number of needs. For example, U.S. Pat. No. 4,912,471 to Tyburski, et al. and U.S. Pat. No. 5,351,052 to D'Hont, et al. disclose the use of RFID systems for the identification of and communication between moving vehicles such as automobiles or railroad cars. Also, U.S. Pat. No. 5,030,807 issued to Landt, et al., U.S. Pat. No. 5,971,437, issued to Sakashita, and U.S. Pat. No. 6,019,394, issued to Chenoweth disclose the use of RFID systems for identification and control of various moveable objects. However, RFID devices and systems have not been used in connection with diagnostic or toxicological specimen containers for identification and control of biomedical specimens and to improve the management of the information associated with such specimens.

### SUMMARY OF THE INVENTION

The present invention fulfills this need in the art by providing a diagnostic specimen container including a collection vessel and a wireless electronic memory tag for non-contact storage and retrieval of information. Preferably, the electronic memory tag includes a radio frequency transponder. The diagnostic specimen container preferably includes data stored on the electronic memory tag including an identification code for the container. Other pertinent information may also be stored on the electronic memory tag, such as the identity of the supplier of the container and product information about the container, identifying information about a specimen contained in the vessel and about the specimen donor, definition of the analytical tests to be performed on the specimen in the vessel, or any other relevant data. Desirably, the diagnostic specimen container also includes a label imprinted with an identifying bar code.

The invention also provides a toxicology specimen container including a collection vessel and a wireless electronic memory tag for non-contact storage and retrieval of information.

In one embodiment, the tag contains only a readable identification code so that the container (whether for diagnostic or toxicological specimens) may be simply identified as unique. A computer record may correlate the identification code with the other pertinent information about the specimen.

The invention also provides a method for electronically storing information on a diagnostic or toxicology specimen container and remotely reading information from the container. This method includes providing a specimen container having a wireless electronic memory tag, electronically storing data on the electronic memory tag, and reading the stored information from the electronic memory tag with a non-contact electronic reader or scanner. This method provides for the storage and retrieval of a large amount of data directly onto and from the container without physical contact.

The invention further provides a method for recording information about a diagnostic or toxicology specimen on a diagnostic or toxicology specimen container including providing a specimen container having a wireless electronic memory tag, collecting a specimen from a donor in the specimen container, and electronically storing information about the specimen, donor, and/or tests to be performed on the specimen on the electronic memory tag. Preferably, this method includes collecting and storing the electronic signature of the specimen donor on the electronic memory tag. This method may also include storing the results of the analytical tests performed on the specimen in the container on the electronic memory tag.

The invention also provides a method for managing the gathering of diagnostic and/or toxicology specimens from multiple specimen collection sites and the delivery of the collected specimens to a reference laboratory. The method includes collecting identity and test data for specimens and specimen donors at multiple collection sites, entering the collected data into collection site computer databases, and transmitting the collected data from the collection site computer databases to a computer at a reference laboratory by an internet connection. Then, the method proceeds by compiling and processing the transmitted data with the laboratory computer to generate a schedule and route for gathering the specimens from the specimen collection sites, gathering the specimens from the specimen collection sites according to the schedule and route, and delivering the specimens to the reference laboratory. Preferably, the data collection includes reading information from electronic memory tags attached to containers containing the specimens by scanning the electronic memory tags with an electronic reader/scanner. Desirably, the data collection also includes scanning bar codes imprinted on labels on the specimen containers. The data collection and entry also preferably includes collecting data into an electronic recording device and uploading the recorded information from the electronic recording device into a local computer at each specimen collection site for storage and transmission. Data collection and entry with the electronic recording device may also include collecting the electronic signatures of specimen donors and entering the electronic signatures of the specimen donors into the local computer database.

The invention also provides a method for controlling the receipt, routing, and testing of diagnostic or toxicology specimens at an automated reference laboratory. This method includes delivering diagnostic and/or toxicology specimens to the automated reference laboratory which are contained in specimen containers having specimen and testing information stored on radio frequency memory tags affixed to the specimen containers. The method includes scanning and reading the specimen and testing information from the electronic memory tags on the specimen containers with electronic scanners or readers, transmitting the information to a microprocessor for controlling the automated laboratory equipment, processing the read information with the microprocessor, and using the processed information to control the sorting, routing, and analytical testing of the specimens by the automated laboratory equipment. The method may also include electronically writing the results of the analytical test or tests for each analyzed specimen to the electronic memory tag on the specimen container containing the corresponding analyzed specimen. This method may also include electronically storing the results of the analytical test or tests and the corresponding specimen identification data on a laboratory computer database. Preferably, the analytical test results data and corresponding specimen identification data stored on the laboratory computer database are transmitted to the corresponding original specimen collection site by an internet connection. Alternatively or in addition, the analytical test results and corresponding specimen identification data stored on the laboratory computer database may be printed to a written test results report.

The invention also provides an integrated method for managing the collection, control, and testing of diagnostic and/or toxicology specimens and for managing the specimen and testing information associated with such specimens. First, encoded specimen containers having electronic memory tags with electronic specimen identification codes stored therein and having bar code labels imprinted with identifying bar codes are provided. Next, the electronic specimen identification code and identifying bar code for each encoded specimen container are correlated and the correlated codes are stored on a central computer database. The encoded specimen containers are then supplied to multiple specimen collection sites and are used to collect specimens from specimen donors at these sites. After gathering data about the collected specimens, specimen donors, and prescribed specimen tests at the specimen collection sites, the data is correlated with the identifying bar codes on the corresponding specimen containers and entered into the collection site computer record. Next, the gathered and stored specimen, donor, and testing data and correlated identity codes are transmitted from the collection site computer to a laboratory computer at an automated reference laboratory, such as by an internet connection.

The received data is then processed at the reference laboratory, and a queue is defined for specimens awaiting collection for delivery to the automated reference laboratory. This queue is used to define a route for collecting the specimens from the specimen collection sites for delivery to the automated reference laboratory. The specimens are then gathered from the specimen collection sites according to the route, and the collected specimens are delivered to the automated reference laboratory. At the reference laboratory, the electronic memory tags on the delivered specimen containers are electronically interrogated to detect the associated electronic identity codes, and the read data is correlated with the specimen data previously transmitted to the laboratory computer database. The specimens are then automatically sorted for testing, and testing schedules are established using the correlated specimen and testing data in the laboratory computer database. Next, the specimens are automatically routed through the automated reference laboratory using the correlated specimen and testing data in the laboratory computer database. The test results are then electronically recorded on the laboratory computer database and the results are correlated with the previously recorded specimen data. Finally, the recorded and correlated test results data is transmitted to remote locations for reporting.

Preferably, data is gathered at the specimen collection sites by scanning the bar codes on the specimen containers with an electronic recording device having a bar code scanner and then entered into the central computer database by electronically uploading the bar code data and other recorded specimen data from the electronic recording device. This method also preferably includes recording and uploading the electronic signatures of the specimen donors using the electronic recording device. Desirably, the routing and testing step at the automated reference laboratory also includes verifying the identity and required testing of each specimen prior to testing by interrogating the electronic memory tag on each specimen container for its electronic identity code and comparing the read code with the correlated specimen and prescribed testing requirements in the laboratory computer database. In addition, it may be preferable to transmit the test results data from the laboratory computer database to the associated specimen collection sites by an internet connection. Alternatively, written test result reports may be printed and delivered to remote sites.

### BRIEF DESCRIPTION OF THE DRAWINGS

The invention will be better understood from a reading of the detailed description of the preferred embodiments along with a review of the drawings in which:

FIG. 1 is a front exterior view of a preferred embodiment;

FIG. 2 is a front detail view of the label of the embodiment of FIG. 1;

FIG. 3 is a rear view of the label of FIG. 2;

FIG. 4 is a block diagram of an integrated system for managing the collection, control, and testing of diagnostic and/or toxicology specimens and for managing the specimen and testing information associated with such specimens using the apparatus shown in FIGS. 1-3; and

FIG. 5 is a flow chart showing the flow of information and data about specimen containers, specimens, and specimen tests between the container supplier, the specimen collection site, and the automated laboratory according to the method shown in FIG. 4.

### DETAILED DESCRIPTION OF THE PREFERRED EMBODIMENTS

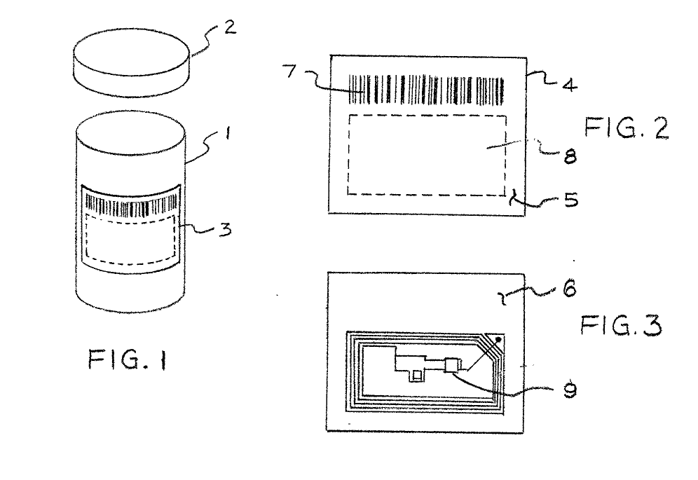

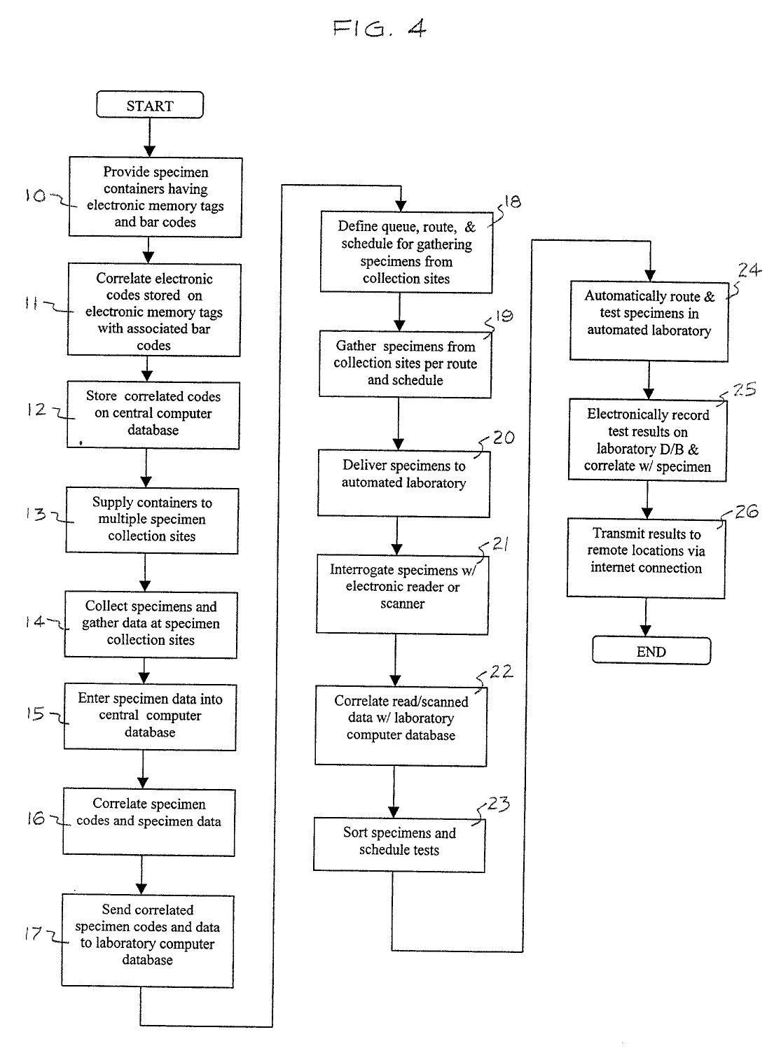

The present invention provides a diagnostic or toxicology specimen container having a wireless electronic memory tag for non-contact storage and retrieval of information. As seen in FIG. 1, a vessel 1 is provided with a cap 2 for sealingly receiving a biomedical specimen within the vessel 1. An electronic memory tag 3 is affixed to an exterior surface of the vessel 1. An enlarged front view of a preferred embodiment of the electronic memory tag 3 is shown in FIG. 2. The electronic memory tag 3 includes a carrier label 4 which has a front face 5 and a rear face 6. Preferably, the front face 5 is imprinted with an identification bar code 7. A text area 8 is also provided for printing, typing, or writing pertinent information on the front face 5 of the carrier label 4. A detail view of the rear face 6 of the carrier label 4 is shown in FIG. 3. An electronic memory device 9 is attached to the rear face 6. Alternatively, the invention may include a separate electronic memory tag 3 and a second printed label having a bar code 7 imprinted thereon (not shown). The apparatus of FIGS. 1-3 may be used for either a diagnostic or toxicology specimen. For toxicology specimens, the specimen containers may further include a tamper-resistant or tamper-evident locking or sealing device (not shown).

In the preferred embodiment, the electronic memory device 9 is an ultra-thin radio frequency transponder made up of an integrated circuit and an antenna. The transponder has no battery, but is energized when interrogated by radio signals from a reader or scanner. The radio frequency transponder may be configured as a read/write, write-once/read-many, or read-only device as required in a particular embodiment of the invention. Details regarding these transponders and the electronic devices to write information to and read information from such devices are known and need not be shown in the detailed drawings to enable those of ordinary skill in the art to practice the invention. Alternatively, other types of compact, non-contact electronic memory devices may also be used.

A unique electronic identification code for the specimen container is stored on the electronic memory device 9, though the electronic memory device 9 may be selected to be capable of storing any desired information within the memory capacity of the device. For example, Tag-It® brand radio frequency identification systems sold by Texas Instruments, Inc., of Dallas Tex. may be used. Other types of information which may also be stored include identifying and contact information of the supplier of the specimen container, product information about the container, the identity of the collection site using the specimen container, the date and time the specimen container is used to collect a specimen, identifying information about a specimen contained in the container and its donor, and definition of the tests to be performed on the contained specimen. This information may be written to the electronic memory device or read from the device by the specimen container supplier, the specimen collection sites using the containers, or a testing laboratory. In a preferred embodiment, the tag is a read-only tag having only a unique identification code so that the container to which it is affixed can be uniquely identified. That unique identification code may then be correlated with more complete data found on a computer. This simplifies and reduces the cost of the tag.

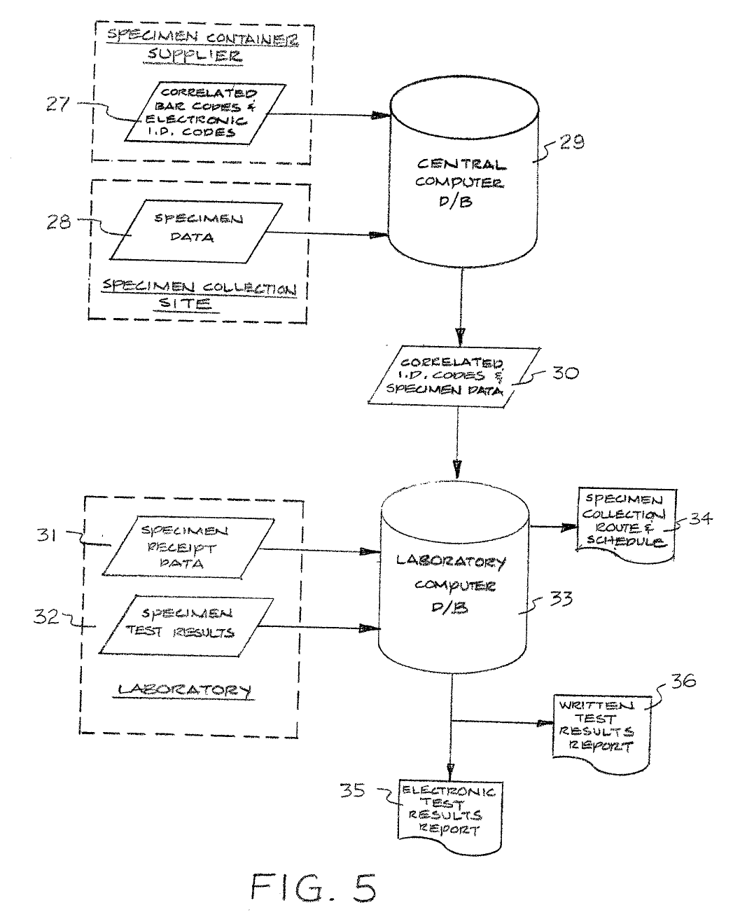

The present invention also provides an integrated system for managing the collection, control, and testing of diagnostic and/or toxicology specimens and for managing the specimen and testing information associated with such specimens. FIG. 4 shows the sequence of events in the preferred method, and FIG. 5 shows the flow of information and data associated with this method. The process begins by first providing 10 specimen containers having electronic memory tags 3 as shown in FIGS. 1-3. Preferably, each container has a unique electronic identification code stored on its electronic memory tag 3 and a bar code 7 imprinted on the front face 5 of its carrier label 4. Each electronic identification code and corresponding bar code 7 are correlated 11 and stored 12 on a central computer database 29. The central computer database 29 provides a cross-reference for future identification and control of the specimen containers using either the bar codes 7 or electronic control codes. The specimen containers are then supplied 13 to multiple specimen collection sites such as hospitals, clinics, and doctors' offices. The bar code is not necessary in all embodiments of the invention.

The provided specimen containers are used to collect 14 biomedical specimens from donors for testing. The specimens may be either diagnostic or toxicology specimens or used in clinical trials. Attendants at the specimen collection site also gather information 14 about each collected specimen, the specimen donor, and the required specimen testing. In this preferred embodiment, the data is collected using an electronic recording device including a bar code scanner for scanning and recording the bar code 7 from each specimen container. Such electronic recording devices are widely known, such as those used in connection with commercial parcel delivery services. One such device 101 is described in U.S. Pat. No. 6,094,642 to Stephenson et al., assigned to Federal Express Corporation. Another such device is disclosed in U.S. Pat. No. 5,313,051 to Brigida, et al., assigned to International Business Machines Corp. The specifications of these two patents are hereby incorporated by reference. The attendant's electronic recording device may include a keypad to permit input of information into the system as well as means for uploading data from the electronic recording device to a computer. The electronic identification code stored on the electronic memory tag may be used to identify the specimen container and the specimen contained therein, but the bar code 7 is a preferred method of identification at the specimen collection sites because of the low relative cost of bar code scanners compared to the readers/scanners required to interrogate the electronic memory tags to detect the electronic identification codes. However, the collection sites may alternatively use the electronic memory codes in lieu of the bar codes 7 when an electronic reader/scanner is available. In addition, collection sites having the capability may electronically write the gathered specimen information to the electronic memory tag on the specimen container holding the associated specimen. For toxicology specimens, the gathered data includes the electronic authorization and identification signatures of the specimen donors. Preferably, the data input software prevents unauthorized tampering with the input data once the signature has been received to enable a reliable chain of custody record to be established.

Next, the gathered identification and specimen data is entered 15 into the central computer database 29 by uploading the data from the electronic recording device or by manual entry. The uploaded data is then correlated 16 with the previously stored specimen container identification data in the central computer database 29.

The correlated data 30 is then transmitted 17 to a laboratory computer database 33 such as by an internet connection. Other connections such as LAN, WAN, dial-up modems or the like can be substituted and, as used herein for internet connections should be construed to include such connections. This data 30 may be used by the laboratory to define 18 a queue of specimens awaiting collection and delivery to the laboratory from the multiple collection sites. The laboratory or other actor then defines 18 a route and schedule 34 for the efficient and timely gathering of specimens from the multiple collection sites and delivery to the laboratory. The specimens are then gathered 19 according to the route and schedule 34 by one or more couriers and delivered 20 to the laboratory.

The delivered specimens are interrogated 21 at the laboratory using an electronic reader/scanner to detect the electronic identification codes stored on the electronic memory tags 3. The specimen containers can be remotely scanned in mass at a receiving station with an electronic reader or scanner, even while still inside their protective shipping cartons or containers, thereby reducing the elapsed time and labor cost associated with identifying and receiving each specimen individually. The data 31 detected from the specimens is input into the laboratory computer database 33 and correlated 22 with the other corresponding specimen data in the laboratory computer database 33. The correlated data is used 23 by a microprocessor controlling the automated laboratory equipment to sort the specimens and schedule the prescribed diagnostic or toxicology tests for each specimen.

For some types of tests, particularly toxicology tests, human inspection of the specimen container is desirable at the laboratory, and the present invention aids this process. As a series of containers pass the inspector, he or she may inspect and input by a simple keystroke or other motion his or her indication that the container is intact and of acceptable quality for the prescribed test. The inspector making such judgment may automatically identify a specimen by scanning its bar code 7 or electronically reading its tag 3.

The sorted and scheduled specimens are then routed through conventional automated handling and testing equipment and tested 24. Test results 32 are electronically recorded 25 and entered into the laboratory database 33. The test results are correlated 25 with the previously stored specimen data 31 and electronic test results reports 35 are transmitted 26 to remote locations via internet connections. Alternatively, written test results reports 36 may be generated and sent to the remote locations.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A diagnostic specimen container comprising a biomedical specimen collection vessel and a wireless electronic memory tag for non-contact storage and retrieval of information.

2. A diagnostic specimen container as claimed in claim 1 wherein the electronic memory tag includes a radio frequency transponder.

3. A diagnostic specimen container as claimed in claim 1 wherein the electronic memory tag contains stored data including an identification code for the container.

4. A diagnostic specimen container as claimed in claim 3 further including a label imprinted with an identifying bar code.

5. A diagnostic specimen container as claimed in claim 1 wherein the electronic memory tag contains stored data including the identity of the supplier of the container and product information about the container.

6. A diagnostic specimen container as claimed in claim 1 wherein the electronic memory tag contains stored data including identifying information about a specimen contained in the vessel and about the specimen donor.

7. A diagnostic specimen container as claimed in claim 6 wherein the electronic memory tag contains stored data further including definition of the analytical tests to be performed on the specimen in the vessel.

8. A diagnostic specimen container comprising:
a collection vessel and a wireless electronic memory tag including a radio frequency transponder for non-contact storage and retrieval of information;
data stored on the electronic memory tag including an identification code for the container, the identity of the supplier of the container and product information about the container, identifying information about a specimen contained in the vessel and about the specimen donor, and definition of the analytical tests to be performed on the specimen in the vessel; and
a label imprinted with an identifying bar code.

9. A toxicology specimen container comprising a collection vessel configured to receive and contain a toxicology specimen and a wireless electronic memory tag for noncontact storage and retrieval of information.

10. A toxicology specimen container as claimed in claim 9 wherein the electronic memory tag includes a radio frequency transponder.

11. A toxicology specimen container as claimed in claim 9 wherein the electronic memory tag contains stored data including an identification code for the container.

12. A toxicology specimen container as claimed in claim 11 further including a label imprinted with an identifying bar code.

13. A toxicology specimen container as claimed in claim 9 wherein the electronic memory tag contains stored data including the identity of the supplier of the container and product information about the container.

14. A toxicology specimen container as claimed in claim 9 wherein the electronic memory tag contains stored data including identifying information about a specimen contained in the vessel and about the specimen donor.

15. A toxicology specimen container as claimed in claim 14 wherein the electronic memory tag contains stored data further including definition of the analytical tests to be performed on the specimen in the vessel.

16. A toxicology specimen container as claimed in claim 9 wherein the electronic memory tag contains stored data including an encoded electronic signature of the donor of a toxicology specimen.

17. A toxicology specimen container comprising:
a biomedical specimen collection vessel and a wireless electronic memory tag including a radio frequency transponder for non-contact storage and retrieval of information;
data stored on the electronic memory tag including an identification code for the container, the identity of the supplier of the container and product information about the container, identifying information about a specimen contained in the vessel and about the specimen donor, definition of the analytical tests to be performed on the specimen in the vessel, and an encoded electronic signature of the donor of the toxicology specimen in the vessel; and a label imprinted with an identifying bar code.

18. A method for electronically storing information on a diagnostic or toxicology specimen container and remotely reading information from the container comprising:
providing a biomedical specimen container having a wireless electronic memory tag;
electronically storing data on the electronic memory tag; and
reading the stored information from the electronic memory tag with a non-contact electronic reader or scanner.

19. A method for recording information about a diagnostic or toxicology specimen on a diagnostic or toxicology specimen container comprising:
providing a biomedical specimen container having a wireless electronic memory tag;
collecting a specimen from a donor in the specimen container; and
electronically storing information about the specimen, donor, and/or tests to be performed on the specimen on the electronic memory tag.

20. A method as claimed in claim 19 further including collecting and storing the electronic signature of the specimen donor on the electronic memory tag.

21. A method as claimed in claim 19 further including storing the results of the analytical tests performed on the specimen in the container on the electronic memory tag.

22. A method for managing the gathering of diagnostic and/or toxicology specimens from multiple specimen collection sites and the delivery of the collected specimens to a reference laboratory comprising:
collecting identity and test data for specimens and specimen donors at multiple collection sites;
entering the collected data into collection site computer databases;
transmitting the collected data from the collection site computer databases to a computer at a reference laboratory by internet connections;
compiling and processing the transmitted data with the laboratory computer to generate a schedule and route for gathering the specimens from the specimen collection sites; and
gathering the specimens from the specimen collection sites according to the schedule and route and delivering the specimens to the reference laboratory.

23. A method as claimed in claim 22 wherein data collection includes reading information from electronic memory tags attached to containers containing the specimens by scanning the electronic memory tags with an electronic reader/scanner.

24. A method as claimed in claim 22 wherein data collection includes scanning bar codes imprinted on labels on the specimen containers.

25. A method as claimed in claim 22 wherein data collection includes entering data into a portable electronic recording device and data entry includes uploading the recorded information from the electronic recording device into a local computer at each specimen collection site.

26. A method as claimed in claim 22 wherein data collection includes collecting the electronic signatures of specimen donors and data entry includes entering the electronic signatures of the specimen donors into the local computer database.

27. A method for controlling the receipt, routing, and testing of diagnostic or toxicology specimens at an automated reference laboratory comprising:
delivering diagnostic and/or toxicology specimens to the automated reference laboratory which are contained in specimen containers having specimen and testing information stored on radio frequency memory tags affixed to the specimen containers;
scanning and reading the specimen and testing information from the electronic memory tags on the specimen containers with electronic scanners or readers and transmitting the information to a microprocessor for controlling the automated laboratory equipment; and
processing the read information with the microprocessor and using the processed information to control the sorting, routing, and analytical testing of the specimens by the automated laboratory equipment.

28. A method as claimed in claim 27 further including electronically writing the results of the analytical test or tests for each analyzed specimen to the electronic memory tag on the specimen container containing the corresponding analyzed specimen.

29. A method as claimed in claim 27 further including electronically storing the results of the analytical test or tests and the corresponding specimen identification data on a laboratory computer database.

30. A method as claimed in claim 29 further including printing the analytical test results and corresponding specimen identification data stored on the laboratory computer database to a written test results report.

31. A method as claimed in claim 29 further including transmitting the analytical test results data and corresponding specimen identification data stored on the laboratory computer database to the corresponding original specimen collection site by an internet connection.

32. A method for managing the collection, control, and testing of diagnostic and/or toxicology specimens and for managing the specimen and testing information associated with such specimens comprising:
providing encoded specimen containers having electronic memory tags with electronic specimen identification codes stored therein and having bar code labels imprinted with identifying bar codes;
correlating the electronic specimen identification code and identifying bar code for each encoded specimen container and storing the correlated codes on a central computer database;
supplying the encoded specimen containers to multiple specimen collection sites;
collecting specimens from specimen donors and placing the specimens in the encoded specimen containers at the specimen collection sites;
gathering data about the collected specimens, specimen donors, and prescribed specimen tests at the specimen collection sites, correlating the gathered data with the identifying bar codes on the corresponding specimen containers, and entering the gathered and correlated data into the central computer database;
transmitting the gathered and stored specimen, donor, and testing data and correlated identity codes from the central computer database to a laboratory computer database at an automated reference laboratory by an internet connection;
processing the received data at the reference laboratory and defining a queue of specimens awaiting collection for delivery to the automated reference laboratory;
using the queue to define a schedule and route for collecting the specimens from the specimen collection sites for delivery to the automated reference laboratory;
gathering the specimens from the specimen collection sites according to the schedule and route and delivering the collected specimens to the automated reference laboratory;
electronically interrogating the electronic memory tags on the delivered specimen containers to detect the associated electronic identity codes and correlating the read data with the specimen data previously transmitted to the laboratory computer database;
automatically sorting the specimens for testing and establishing testing schedules using the correlated specimen and testing data in the laboratory computer database;
automatically routing and testing the specimens through the automated reference laboratory using the correlated specimen and testing data in the laboratory computer database;
electronically recording the test results on the laboratory computer database and correlating the results with the previously recorded specimen data; and
transmitting the recorded and correlated test result data to remote locations.

33. A method as claimed in claim 32 wherein the data gathering at the specimen collection sites includes scanning the bar codes on the specimen containers with an electronic recording device having a bar code scanner and data entry at the specimen collection sites includes electronically uploading the bar code data and other recorded specimen data from the electronic recording device to the central computer database.

34. A method as claimed in claim 33 further including recording and uploading electronic signatures of the specimen donors using the electronic recording device.

35. A method as claimed in claim 32 wherein the routing and testing step at the automated reference laboratory includes the step of verifying the identity and required testing of each specimen prior to testing by interrogating the electronic memory tag on each specimen container for its electronic identity code and comparing the read code with the correlated specimen and prescribed testing requirements in the laboratory computer database.

36. A method as claimed in claim 32 wherein the transmission includes transmitting the test results data from the laboratory computer database to the associated specimen collection sites by an internet connection.

37. A method as claimed in claim 32 further including printing written test result reports and delivering the written test result reports to remote sites.
